(19) United States
(12) Patent Application Publication
(10) Pub. No.: US 2026/0181678 A1
(43) Pub. Date: Jun. 25, 2026

(54) METHOD AND APPARATUS FOR CHOOSING TRANSMISSION PARAMETERS VALUES IN A MULTI-USER TRANSMISSION

(71) Applicant: CANON KABUSHIKI KAISHA, Tokyo (JP)

(72) Inventors: Pascal VIGER, JANZE (FR); Stéphane BARON, LE RHEU (FR); Patrice NEZOU, LIFFRE (FR)

(21) Appl. No.: 19/540,416

(22) Filed: Feb. 13, 2026

Related U.S. Application Data
(63) Continuation of application No. 17/774,454.

(30) Foreign Application Priority Data
Nov. 8, 2019 (GB) 1916306.2
Dec. 20, 2019 (GB) 1919056.0

(51) Int. Cl. H04W 72/30; H04W 72/0446; H04W 72/0453; H04W 84/12

(52) U.S. Cl. CPC H04W 72/30; H04W 72/0446; H04W 72/0453; H04W 84/12

(57) ABSTRACT

Aspects of the present disclosure generally relate to enhanced multi-user (MU) uplink (UL) protocols in wireless networks that allow a station to choose values for the transmission parameters in a multi-user transmission. More particularly, embodiments of the invention relate to a method for wireless communication comprising, at a station (STA): receiving, from an access point (AP), a trigger frame to trigger a multi-user (MU) transmission, wherein the trigger frame allocates a resource unit of the MU transmission for data transmission from the STA using a set of transmission parameters; choosing, by the STA, values for the set of transmission parameters; and sending a data frame over the resource unit of the MU transmission allocated by the AP to the STA using the values chosen by the STA.

### CROSS REFERENCE TO RELATED APPLICATION

This application is a Continuation of U.S. patent application Ser. No. 17/774,454, filed on May 4, 2022, which is the National Phase application of PCT Application No. PCT/EP2020/081240, filed on Nov. 6, 2020, which claims the benefit under 35 U.S.C. § 119(a)-(d) of United Kingdom Patent Application No. 1916306.2, filed on Nov. 8, 2019, and entitled “METHOD AND APPARATUS FOR STATION CHOSEN VALUES OF TRANSMISSION PARAMETERS IN A MULTI-USER TRANSMISSION”, and United Kingdom Patent Application No. 1919056.0, filed on Dec. 20, 2019, and entitled “METHOD AND APPARATUS FOR STATION CHOSEN VALUES OF TRANSMISSION PARAMETERS IN A MULTI-USER TRANSMISSION”. The above cited patent applications are incorporated herein by reference in their entirety.

### FIELD OF THE INVENTION

The present invention generally relates to wireless communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth and decreasing latency requirements that are demanded for wireless communications systems in high-density environments, multi-user (MU) schemes are being developed to allow a single access point (AP) to schedule MU transmissions, i.e. multiple simultaneous transmissions to or from non-AP stations, in the wireless network. For example, one of such MU schemes has been adopted by the Institute of Electrical and Electronics Engineers (IEEE) in the 802.11ax standard, draft version 3.0 (D3.0) of June 2018.

Thanks to the MU feature, a station has the opportunity to gain access to the wireless medium via two access schemes: the MU scheme and the conventional Enhanced Distributed Channel Access-EDCA (Single User) scheme.

The 802.11ax standard allows a MU downlink (DL) transmission to be performed by the AP where the latter can perform multiple simultaneous elementary transmissions, over so-called resource units (RUs), to various non-AP stations. As an example, the resource units split a communication channel of the wireless network in the frequency domain, based for instance on Orthogonal Frequency Division Multiple Access (OFDMA) technique. The assignment of the RUs to the stations is signaled at the beginning of the MU Downlink frame, by providing an association identifier (AID) of a non-AP station (individually obtained by each station during its association procedure with the AP) for each RU defined in the transmission opportunity.

The 802.11ax standard also allows a MU uplink (UL) transmission to be triggered by the AP, where various non-AP stations can simultaneously transmit to the AP over the resource units forming the MU UL transmission. To control the MU UL transmission by the non-AP stations, the AP sends a control frame, known as a Trigger Frame (TF), by which it allocates the resource units to the non-AP stations using 16-bit Association IDentifiers (AIDs) assigned to them upon registration to the AP and/or using reserved AIDs designating a group of non-AP stations.

The adopted 802.11ax MU transmission scheme is not adapted to bandwidth-demanding communication services, e.g. video-based services such as gaming, virtual reality, streaming applications. This is because all the communications go through the AP, thereby doubling the air time for transmission but also the number of medium accesses (and thus of medium access time).

The Single User (SU) scheme of 802.11 network protocol allows a direct link (DiL, also called peer-to-peer (P2P) transmission) to be performed wherein the data (MAC) frames are addressed using the 48-bit IEEE MAC address of the destination station. However, SU and MU schemes directly compete one against the other to gain access to the wireless medium (by the AP for MU schemes, by a non-AP station for the SU scheme). In high density environments, this competition generates a large amount of undesirable collisions, thereby degrading latency and overall useful data throughput.

More generally, 802.11 is seen as not being adapted to direct link transmissions, and MU transmissions as conventionally specified can be improved.

### SUMMARY OF INVENTION

It is a broad objective of the present invention to improve this situation.

In order to take advantage of the high benefits of the transmission scheduling made by the AP in high density environments, the inventors have contemplated allowing a station to control and signal values of the transmission parameters while using a resource unit allocated within a multi-user transmission.

An aspect of the present disclosure provides a method for wireless communication comprising, at a station (STA):
receiving, from an access point (AP), a trigger frame to trigger a multi-user (MU) transmission, wherein the trigger frame allocates a resource unit of the MU transmission for data transmission from the STA using a set of transmission parameters and wherein the resource unit occupies a frequency bandwidth that is multiple of 20 MHz channels;
choosing, by the STA, values for part or all of the set of transmission parameters; and
sending a data frame over the resource unit of the MU transmission allocated by the AP to the STA using the values chosen by the STA.

Another aspect of the present disclosure provides a method for wireless communication comprising, at a station (STA):
receiving, from an access point (AP), a trigger frame to trigger a multi-user (MU) transmission, wherein the trigger frame allocates a resource unit of the MU transmission for data transmission from the STA using a set of transmission parameters and wherein the resource unit occupies a frequency bandwidth that is multiple of 20 MHz channels;
determining values for the set of transmission parameters; and
sending a data frame over the resource unit using the determined values;
wherein the determining comprises either choosing values by the STA if one or more conditions are fulfilled, or retrieving values provided by the AP otherwise.

A further aspect of the present disclosure provides a method for wireless communication comprising, at a station (STA):
receiving, from an access point (AP), a trigger frame to trigger a multi-user (MU) transmission, wherein the trigger frame allocates a resource unit of the MU transmission for data transmission from the STA using a set of transmission parameters and wherein the resource unit occupies a frequency bandwidth that is multiple of 20 MHz channels;
determining values for the set of transmission parameters; and
sending a data frame over the resource unit using the determined values;
wherein the determining is based on an indication from the AP indicating whether the STA is allowed or not to choose values for the set of transmission parameters.

Yet a further aspect of the present disclosure provides method for wireless communication comprising, at an access point (AP):
sending a trigger frame to trigger a multi-user (MU) transmission, wherein the trigger frame allocates a resource unit of the MU transmission for data transmission from a station (STA) using a set of transmission parameters and wherein the resource unit occupies a frequency bandwidth that is multiple of 20 MHz channels; and
sending an indication indicating whether the STA is allowed to choose values of the set of transmission parameters for transmitting data over the resource unit.

Yet a further aspect of the present disclosure provides a method for wireless communication comprising, at a second access point (AP):
receiving, from a first AP, a trigger frame to trigger a multi-user (MU) transmission, wherein the trigger frame allocates a resource unit of the MU transmission for the second AP to manage data transmission using a set of transmission parameters and wherein the resource unit occupies a frequency bandwidth that is multiple of 20 MHz channels;
choosing, by the second AP, values for the set of transmission parameters; and
sending a data frame over the resource unit of the MU transmission allocated by the first AP using the values chosen by the first AP.

In a variant, the data frame is sent by a station belonging to a basic service set (BSS) that is managed by the second AP.

Another aspect of the invention relates to a non-transitory computer-readable medium storing a program which, when executed by a microprocessor or computer system in a device, causes the device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates a typical wireless communication system in which embodiments of the invention may be implemented;

FIG. 2 illustrates a trigger-based (TB) Multi-User (MU) transmission;

FIG. 3a illustrates the format of a HE SU PPDU;

FIG. 3b illustrates the format of a HE MU PPDU;

FIG. 3c illustrates the format of a HE TB PPDU;

FIG. 4 illustrates using a flowchart, embodiments of the invention implemented at a non-AP station to configure its HE TB PPDU transmission as a result of a received Trigger Frame according to embodiments of a first aspect of the invention;

FIG. 5 illustrates using a flowchart, embodiments of the invention implemented at a non-AP station to configure its HE TB PPDU transmission as a result of a received Trigger Frame according to embodiments of a second aspect of the invention;

FIG. 6 illustrates using a flowchart, embodiments of the invention implemented at an AP according to embodiments of a second aspect of the invention;

FIG. 7 illustrates the structure of a Trigger Frame according to embodiments of the invention;

FIG. 8a illustrates a transmission sequence according to embodiments of the invention;

FIG. 8b illustrates another transmission sequence according to embodiments of the invention, wherein the RU for which an indicator is set has a 20 MHz width;

FIG. 8c illustrates another transmission sequence according to embodiments of the invention, wherein the RU for which an indicator is set can be perceived as an allocation of band for a given set of stations;

FIG. 8d illustrates another transmission sequence according to embodiments of the invention;

FIG. 9a shows a schematic representation a communication device in accordance with embodiments of the present invention;

FIG. 9b shows a schematic representation of a wireless communication device in accordance with embodiments of the present invention; and

FIG. 10 illustrates using a flowchart, embodiments of the invention implemented at a destination station.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless station implemented in accordance with the teachings herein may comprise an access point (so-called AP) or not (so-called non-AP station or STA).

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

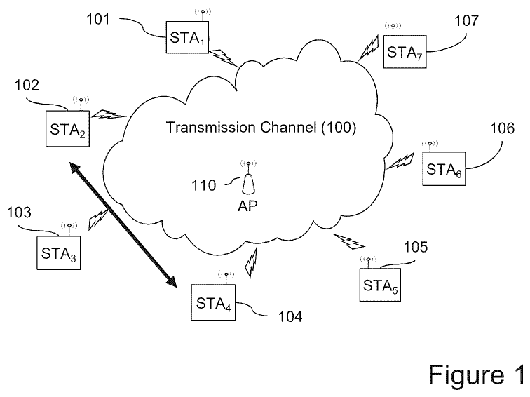

FIG. 1 illustrates a wireless communication system in which several communication stations 101-107, 110 exchange data frames over a radio transmission channel 100 of a wireless local area network (WLAN), under the management of a central station, namely access point (AP) 110. In a variant, direct communications between STAs can be implemented without the use of an access point (known as an Ad-hoc mode). The radio transmission channel 100 is defined by an operating frequency band constituted by a single channel or a plurality of channels forming a composite channel.

Exemplary situation of direct communications, corresponding to an increasing trend nowadays, is the presence of peer-to-peer (P2P) transmissions in between non-AP stations, e.g. STA 102 and STA 104 illustrated in the Figure. Technologies that support P2P transmissions are for example WiFi-Miracast® r Wireless Display scenario, or Tunneled Direct Link Setup (TDLS). Note that even if P2P flows are usually not numerous, the amount of data per flow may be huge (typically low-compressed video, from 1080p60 up to 8K UHD resolutions).

Each STA 101-107 registers to the AP 110 during an association procedure. During the association procedure, the AP 110 assigns a specific Association IDentifier (AID) to the requesting STA. For example, the AID is a 16-bit value uniquely identifying the STA.

The stations 101-107, 110 may compete one against another using EDCA (Enhanced Distributed Channel Access) contention, to access the wireless medium in order to be granted a transmission opportunity (TXOP) and then transmit (single-user, SU) data frames. The stations may also use a multi-user (MU) scheme in which a single station, usually the AP 110, is allowed to schedule a MU transmission, i.e. multiple simultaneous transmissions to or from other stations, in the wireless network. One implementation of such a MU scheme has been for example adopted in IEEE 802.11ax amendment standard, as the Multi-User Uplink and Downlink OFDMA (MU UL and DL OFDMA) procedures.

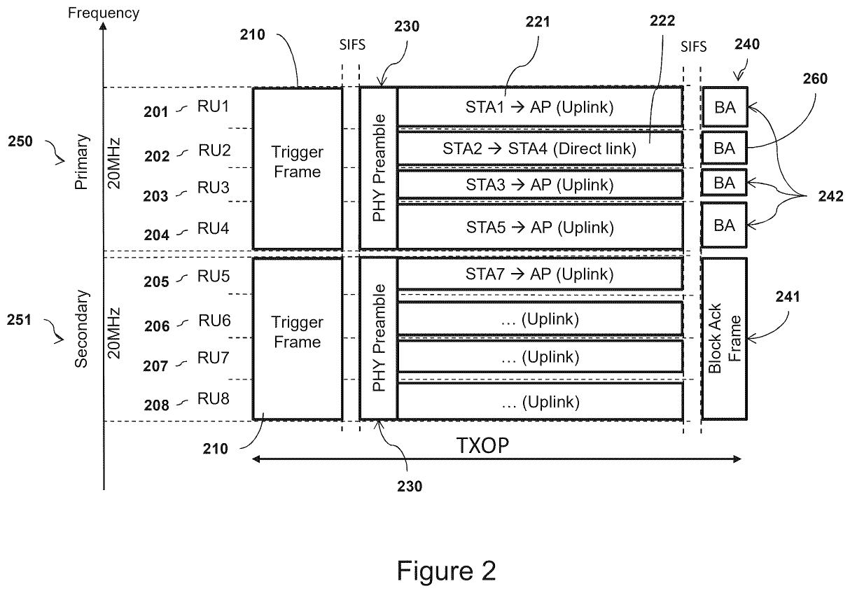

FIG. 2 illustrates a trigger-based (TB) Multi-User (MU) transmission that includes, in addition to MU uplink (UL) transmissions to the AP, a MU transmission directed to a STA, i.e. a direct link (DiL) transmission.

The illustrated MU transmission is triggered by a trigger frame (TF) 210. The TF is a control frame, according to the IEEE 802.11 legacy non-HT format, and is sent over the primary 20 MHz channel 250 and duplicated (replicated) on each other 20 MHz channel 251 forming the targeted composite channel. Due to the duplication of the control frame, it is expected that every nearby legacy station (non-HT or 802.11ac stations) receiving the TF on its primary channel, sets its NAV to the value specified in the header of the TF. This prevents these legacy stations from accessing the channels of the targeted composite channel during a transmission opportunity (TXOP).

A station receiving the trigger frame is referred to as triggered station, while the station sending the trigger frame is referred to as triggering station.

The TF illustrated in FIG. 2 offers a DiL transmission capability within the triggered MU transmission (222) by allocating a resource unit (RU) 202, in addition to Uplink (UL) capabilities (e.g. 221) by allocating resource units (RUs) 201, 203-208.

A resource unit (201-208) is formed by a group of sub-carriers, preferably adjacent, encompassed in the composite channel. This means that the frequency bandwidth of the composite channel is greater than or equal to that of the resource unit. The RUs may be allocated for scheduled or random access.

A triggered station may send a data frame using a physical (PHY) preamble 230 directly to a destination triggered station using a RU allocated, by the trigger frame, for direct link transmission towards that destination triggered station. The destination triggered station may then receive a data frame over the RU allocated for DiL data transmission.

Once the stations have used the Scheduled and/or Random RUs to transmit data to the AP, the AP responds with a Multi-User acknowledgment to acknowledge the data received on each RU. Acknowledgment frame 240 can follow the NON_HT PPDU format (241) or the HE MU PPDU format (242) when sent on an OFDMA RU.

For the DiL RU, it may be envisaged that a receiving DiL destination station may emit an acknowledgment 260 inside the same RU where the DiL transmission has occurred. Acknowledgment frame 260 can follow the SU format but has to be located in the same RU location as the DiL RU.

High-Efficiency (HE) frames have been introduced in 802.11ax. These frames start with the same preamble (L-STF, L-LTF and L-SIG) readable by any station (for backward compatibility), and continue with a preamble and a Data field. The HE preamble can only be decoded by 802.11ax (and forward compatible) devices and is included in various types of HE frames, for example, HE single user (SU) PPDU used for single user transmissions, HE MU (Multi-User) PPDU used for transmissions to one or more stations, in particular for MU downlink (DL) transmissions from the AP to non-AP stations, and HE trigger-based (TB) PPDU (HE_Trig) used for uplink (UL) transmissions from non-AP stations to the AP, in response to a trigger frame.

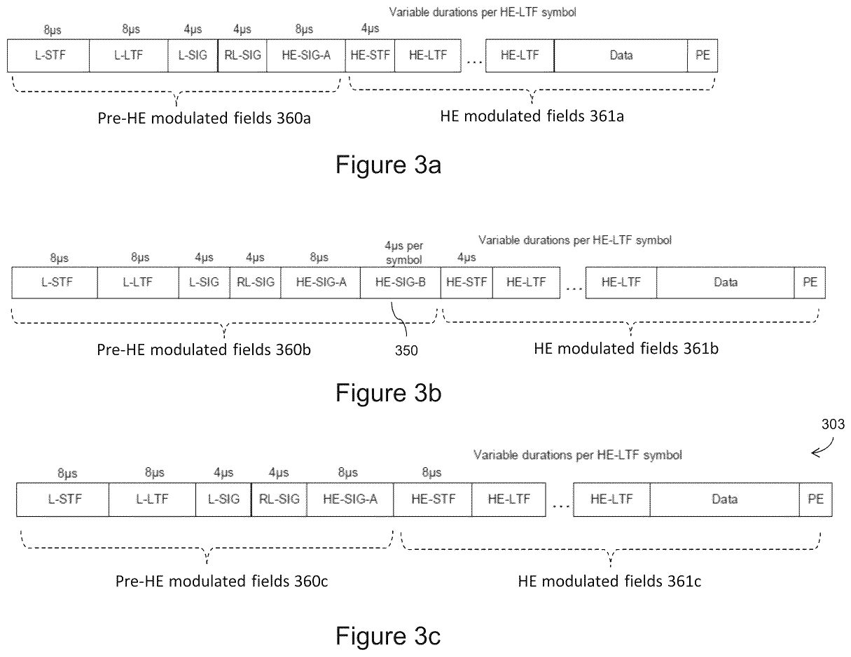

FIGS. 3a, 3b and 3c illustrate the format of, respectively, HE SU PPDU, HE MU PPDU and HE TB PPDU frames. These HE frames as used as examples in describing embodiments of the invention, but other formats can of course be envisaged. For example, Extremely-High-Throughput (EHT) frames introduced in 802.11be may well be used too.

FIG. 3a illustrates the format of a HE SU PPDU. It includes in addition to the conventional preamble (L-STF, L-LTF, L-SIG), RL-SIG (Repeated Legacy Signal Field), HE-SIG-A (HE SIGNAL A), HE-STF (HE Short Training Field), HE-LTF (HE Long Training Field), Data and PE (Packet Extension) fields. Legacy preamble and HE-SIG-A are duplicated on each 20 MHz channel. The HE-SIG-A field includes multiple subfields indicating at set of transmission parameters of the PPDU, such as bandwidth (BW), a modulation and coding scheme (MCS), a number of data streams, a coding type, etc.

FIG. 3b illustrates the format of a HE MU PPDU. It includes the fields as HE SU PPDU, with an additional field 350, namely HE-SIG-B (HE SIGNAL B), used to tell the non-AP stations in which resource unit they will find their data. HE-SIG-B 350 thus defines how the RUs forming the DL MU transmission are assigned to the non-AP stations, for the latter to efficiently receive their own data from the AP.

FIG. 3c illustrates the format of a HE TB PPDU (HE-Trig). The HE-Trig frame has a format quite similar to the one of HE SU PPDU, except the duration of the HE-STF field is 8 μs. In particular, it does not include an HE-SIG-B field because the RU allocation to non-AP stations has already been defined by in the trigger frame. The format 303 can be an example of the frame (preamble & data) 230_221 shown in FIG. 2.

The fields of the various types of HE frames can be classified in a first group of Pre-HE modulated fields (360a, 360b, 360c), and a second group of HE modulated fields (361a, 361b, 361c).

In the HE TB PPDU, the pre-HE modulated fields (360c), which include L-STF, L-LTF, L-SIG, RL-SIG and HE-SIG-A fields, are sent only on the 20 MHz channels where the STA's HE modulated fields are located. If the HE modulated fields are located in more than one 20 MHz channel, the pre-HE modulated fields are duplicated over the multiple 20 MHz channels. This corresponds to the representation 230 of FIG. 2.

As a consequence of receiving a TF, the transmission of data by the triggered stations in the RUs 201-208 is made using HE Trigger-Based PPDUs (HE_Trig) as shown in FIG. 3c or a variant thereof in each RU accessed by the stations. This format is used for a transmission that is a response to a Trigger frame (or equivalent through the 802.11ax TRS mechanism standing for Triggered-response-Scheduling). Each HE-Trig PPDU carries a single transmission (i.e. from one station) in response to the trigger frame.

The various formats show that the stations may have knowledge of the RUs forming a MU transmission and of the RU allocations through the trigger frame which triggers an uplink (UL) communication or the physical preamble field (the HE-SIG-B field 350) of the HE MU PPDU used for downlink (DL) communication.

In addition, a station can transmit PPDUs according to the different formats with a set of different transmission parameters, such as channel width, rate (or MCS, standing for Modulation and Coding Scheme), etc.

Among the set of transmission parameters, the HE-MCS parameter (that is to say, the MCS used for HE or 802.11ax devices) is a compact representation of the modulation and coding used in the HE-SIG-B and Data fields of the PPDU. For an HE SU PPDU, it is carried in the HE-SIG-A field. For an HE MU PPDU it is carried per user in the User Specific field of the HE-SIG-B field. For an HE TB PPDU, it is carried in the User Info field of the Trigger frame soliciting the HE TB PPDU. As one can note, the MCS is usually indicated by the sender stations for HE SU PPDU and HE MU PPDU, while it is indicated by the receiving stations for HE TB PPDU (the receiving station being the AP, which emits the TF handling such parameter). Due to the addition of a new modulation technique (QAM-1024), two new MCS indexes are now available with 802.11ax (MCS indexes are now between 0 to 11).

Conventional MU transmission imposes that preamble 230 is the same for all transmissions, more precisely for 802.11ax the pre-HE modulated fields 360c (composing the preambles 230) are the same and are emitted on each 20 MHz band. Consequently, values of the transmission parameters (included in the HE-SIG-A field) are the same and do not represent the most appropriate values that would be chosen by the station for a given transmission.

This constraint reduces system performances for situations where a station needs to choose different values for the transmission parameters while taking benefit from a RU allocated within a MU transmission.

Embodiments of the invention in its different aspects advantageously use the preambles of the data frames to transport values for the transmission parameters that are adapted for each transmission while the data frames are sent in a MU transmission.

According to one aspect, embodiments of the present invention provide that a STA chooses values for the set of transmission parameters to be used for sending a data frame.

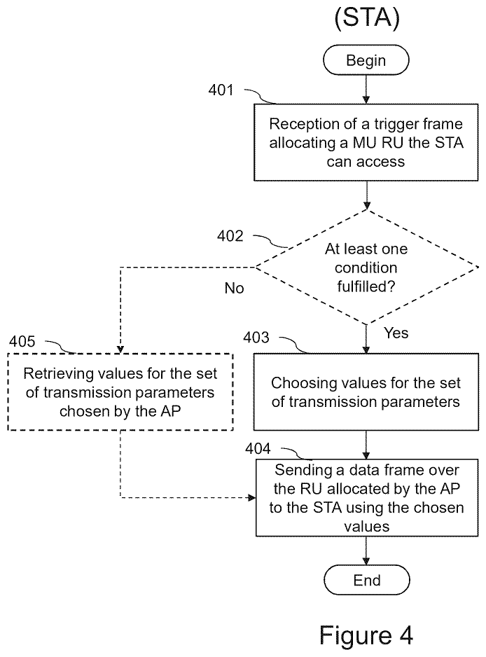

FIG. 4 illustrates using a flowchart an example of a wireless communication method performed at a station according to embodiments of the first aspect of the invention.

At step 401, a trigger frame is received from an AP of a basic service set (first BSS) to trigger a multi-user (MU) transmission. The TF frame allocates a resource unit of the MU transmission that the STA can access for sending a data frame using a set of transmission parameters.

At step 403, the STA chooses values for (part or all of) the set of transmission parameters, and at step 404 the STA sends the data frame (HE TB PPDU) over the RU of the MU transmission allocated by the AP to the STA using the values chosen by the STA.

Optionally, the execution of step 403 is conditional upon the fulfillment of one or more conditions (step 402). If the one or more conditions are not fulfilled, the STA may retrieve values for the set of transmission parameters as chosen by the AP (step 405). In one implementation, these values are retrieved from the trigger frame transmitted by the AP. For example, the AP chosen values are retrieved from the User Info field of the trigger frame as defined in accordance with IEEE 802.11ax standard.

According to one embodiment, one condition is that the resource unit of the MU transmission is allocated for sending the data frame in direct link, DiL, from the STA towards another STA. This advantageously allows the STA to choose the most appropriate values for sending the data frame towards the destination STA.

According to one embodiment, one condition is that the resource unit of the MU transmission is allocated to a station that acts as an AP (second AP) relatively to a second BSS, other than the first BSS. The STA is seen, relatively to the first AP, as a device (e.g. a station unassociated with the first AP). The second AP uses the resource unit of the MU transmission allocated to it to manage data exchange between stations/second AP. Stations managed by the second AP are those of the second BSS, although the second AP may further sublease part or all of the allocated resource unit to a station not belonging to the second BSS. This advantageously allows the second AP to choose the most appropriate values of parameters for sending a data frame towards a destination station of the second BSS, and/or for receiving a data frame from a source station of the second BSS.

The first and second APs may be part of an inter-AP coordination group, for which group formation is out of scope of the invention (one may consider issuing management frames, like beacons or dedicated broadcasted frames, for advertisement of the multi-AP coordination capability). The first AP can be called as coordinator AP, the second AP can be seen as a coordinated AP. The first AP may use a dedicated identifier, such as a MAC address of the STA or BSSID of the second BSS, to signal that the resource unit is allocated for the station acting as AP. In fact, the station may not be associated with the first AP and thus the station does not have an AID assigned to it by the first AP.

According to one embodiment, one condition is that the resource unit occupies a frequency band that is formed of a multiple of 20 MHz channels (e.g. 20, 40, 60, 80, 160, 320 MHz). Since the STA is the only transmitter in a 20 MHz channel forming the frequency band, the preamble of the STA is not superposed with a preamble of one or more other STAs, and thus the STA has the freedom to adapt appropriately the values of the transmission parameters communicated in the preamble.

According to one embodiment, one condition is that a value provided by the AP is not recognized, not supported or cannot be satisfied by the STA.

According to one embodiment, one condition is that the STA is the only station sending a preamble over each 20 MHz channel of the composite channel. In fact, as the sending of the data frame comprises sending the payload over the resource unit and sending the preamble over (encompassing) each 20 MHz channel of the composite channel, when the STA is the only station sending its preamble, the STA has the freedom to choose the most appropriate values for sending the data frame towards the destination AP or non-AP station (i.e. without being forced to have the same preamble than other STAs).

Because the STA is allowed to choose values for the set of the transmission parameters, the value chosen by the STA, for at least one transmission parameter, may be different from the value chosen by the AP as specified in the User Info field for example.

In one embodiment, the STA is allowed to choose values for certain parameters of the set of transmission parameters and the STA is not allowed to choose for certain other parameters of the set, i.e. for the latter the STA is required to take the values provided by the AP. For example, the AP may want to control the received strength (RSSI) of the signal that will be sent by the STA by controlling the emission power of the STA, and thus the AP excludes that parameter from the set of transmission parameters the STA is allowed to choose. In a variant, the STA is allowed to choose values for part or all of the transmission parameters but under constraints, such as for example, allowing the STA to choose a parameter value as long as it remains in a certain range of values.

In one embodiment, the data frame uses a single-user (SU) format over the resource unit of the MU transmission. In a particular implementation, the SU format used is the HE SU PPDU format in accordance with IEEE 802.11ax standard.

In one embodiment, the data frame uses a multi-user (MU) format over the resource unit of the MU transmission. In a particular implementation, the MU format used is the HE MU PPDU format in accordance with IEEE 802.11ax standard (alternatively, an EHT MU PPDU format could be envisaged according to IEEE 802.11be standard). The MU format has an HE-SIG-B field that contains additional information (e.g., the identifier of the transmitter) that can be used by the recipient of the UL HE MU PPDU to determine the transmitter of the PPDU even in those cases where the Data field of the PPDU is not received.

In one embodiment, the data frame contains a Trigger Frame in order to trigger a (second) MU transmission from stations of a second BSS over the resource unit of the (first) MU transmission triggered by the first AP. In this embodiment, the triggered station is a second AP, different from the triggering AP (first AP).

According to another aspect, embodiments of the present invention provide that a STA determines values for the set of transmission parameters to be used for sending a data frame based on an indication from the AP. The indication may indicate whether the STA is allowed or not to choose values for the set of transmission parameters. In a variant, the indication may indicate whether values for the set of transmission parameters to be used by the STA for transmitting data over the resource unit are provided by the AP or are chosen by the STA.

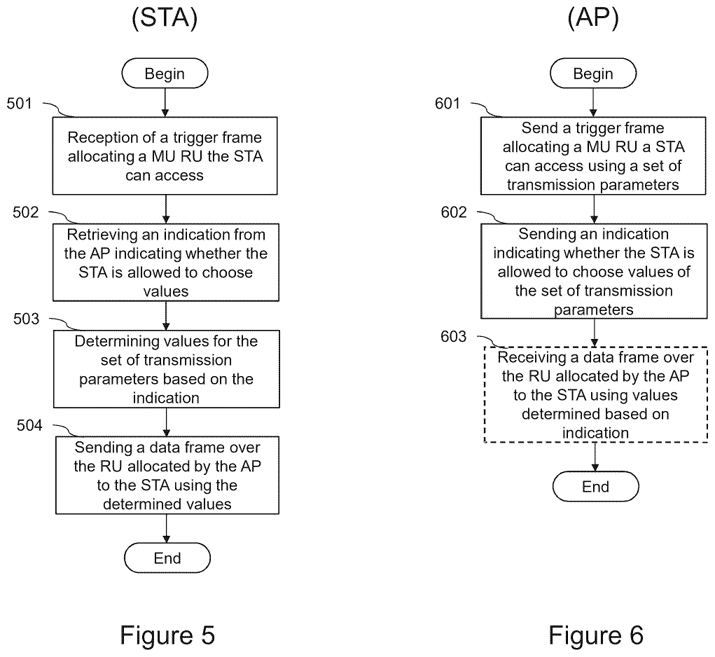

FIG. 5 illustrates using a flowchart an example of a wireless communication method performed by a station to configure its HE TB PPDU transmission as a result of a received Trigger Frame according to embodiments of a second aspect of the invention.

At step 501, the STA receives a trigger frame allocating a MU RU the STA can access for sending data. The RU can be either a scheduled RU for the STA or a Random RU.

At step 502, the STA retrieves an indication from the AP indicating whether the STA is allowed to choose values. The indication is preferably retrieved from a field of the trigger frame.

The STA decodes the received trigger frame, and determines RUs described in the trigger frame identifying the STA as a source station (for a UL MU transmission or a non-UL (i.e. DiL) MU transmission), or as a destination station for a non-UL (i.e. DiL) MU transmission declared in the trigger frame.

This may be done by analyzing User Info fields 710 declared in trigger frame 700, and more specifically by analyzing AID12 subfield 711, and/or Trigger Dependent User Info subfield 714 used by AP 110 to declare the DiL RU with the destination non-AP station and, when required (for DiL), the source station. Alternatively to the use of AIDs to signal stations involved in the RUs, their MAC addresses may be signaled and used instead.

In an embodiment, at most one RU is eligible for (DiL) reception for the STA in the RU allocation list provided by trigger frame 700.

In an embodiment, at least one RU is eligible for (DiL) transmission for the STA in the RU allocation list provided by trigger frame 700.

In an embodiment, such RU eligible for (DiL) reception and RU eligible for (DiL) transmission are exclusive one to the other, in order the STA either receive or transmit, but does not perform both at the same time.

At step 503, the STA determines values for the set of transmission parameters based on the indication, and at step 504, the STA sends a data frame over the RU allocated by the AP using the determined values. The data frame is sent either to the AP or to another STA (or STAs).

In embodiments of step 503, if it is determined that the STA is the source triggered station for RU with an indicator specifying that the STA decides about the values of the transmission parameters, the STA chooses values in a similar way to when the STA has choose values for sending using EDCA (e.g. to send a data frame in single user mode). For example, the MCS is selected according to perceived signal quality by the destination station. The PHY preamble will have the same width as the related data.

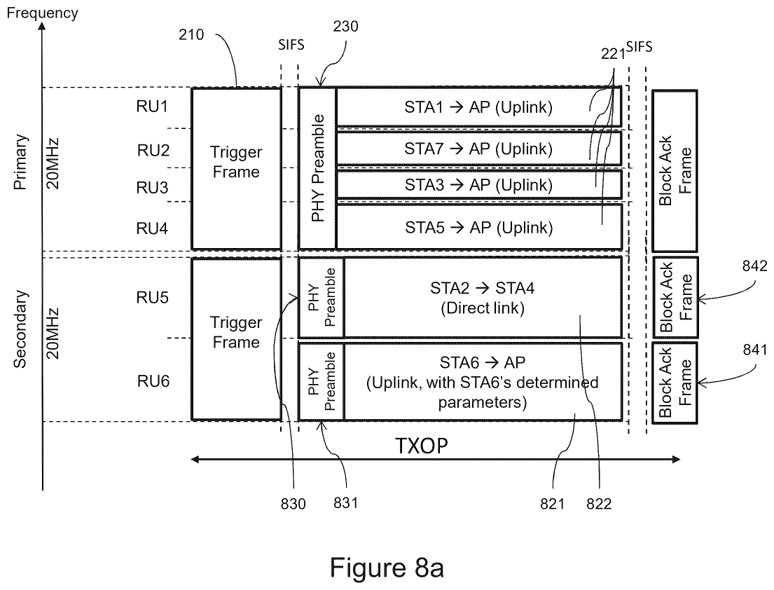

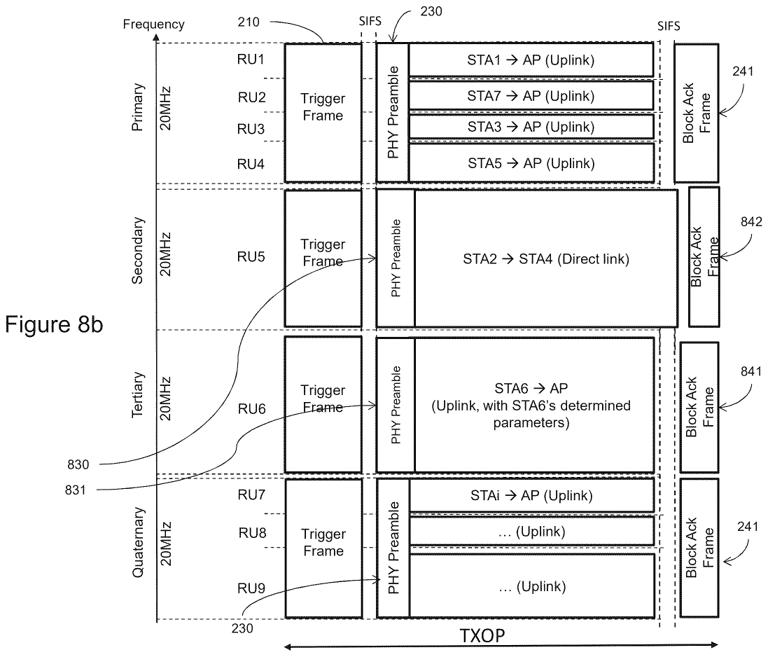

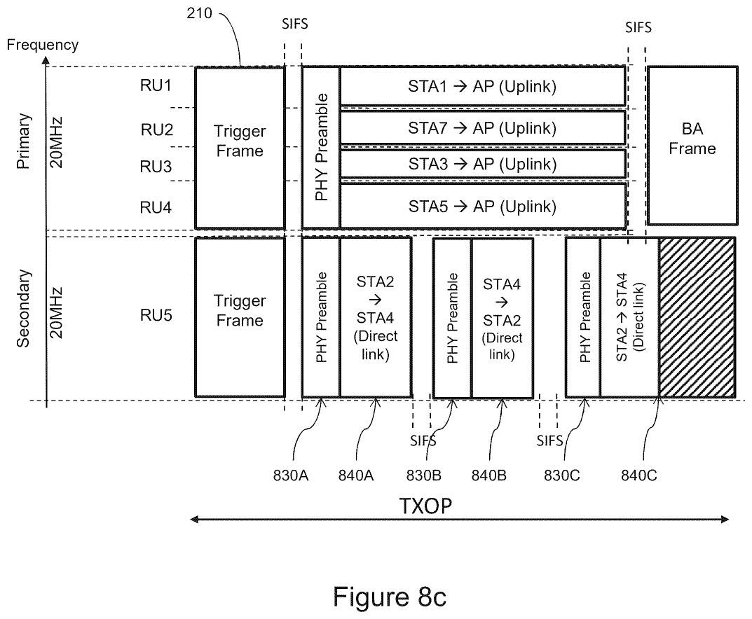

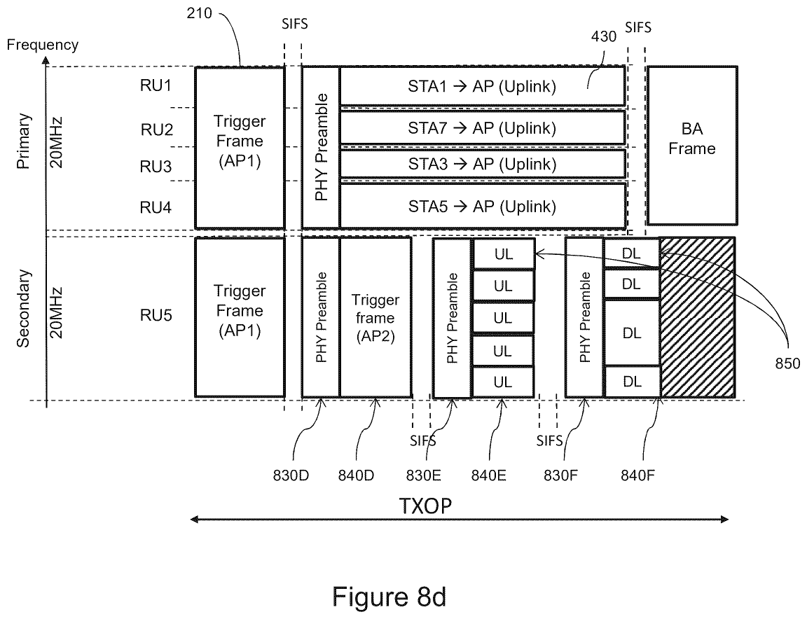

In embodiments where the RU has a 20 MHz width (e.g. as addressed through FIGS. 8b to 8d), the PHY preamble will also have a 20 MHz width whereas the related data has a narrow width. For example, an empty 26-tone RU may be contemplated at one (or both) bounds of the 20 MHz channel, in order to reduce interference from/towards adjacent 20 MHz channels.

In one embodiment, the UL Target RSSI subfield can be considered by the STA. The value of the Target RSSI indicates, in a dBm value, the expected receive power at the AP across all antennas for the assigned resource unit transmissions from the uplink 802.11ax clients. Based on this information provided by the trigger frame, the STA may adjust its selected MCS in order to comply with the transmit power requested by the AP.

All embodiments and variants described for the first aspect also apply for this second aspect of the invention. For example, if the STA is allowed to choose values, the choosing could be restricted to a subset of the transmission parameters and/or to a range of values.

FIG. 6 illustrates using a flowchart, embodiments of the invention implemented at an AP according to embodiments of a second aspect of the invention.

At step 601, the AP sends a trigger frame to trigger a multi-user (MU) transmission. The TF allocates a resource unit of the MU transmission for data transmission from a STA using a set of transmission parameters.

In case of DiL transmission, various means may be envisaged to identify the station(s) involved in the transmission. The following examples may be considered.

As discussed above, an RU is conventionally associated with an identifier (called “AID12”) inside the Trigger Format according to the 802.11ax (e.g. the “Per-User Info” field of a RU embeds an “AID12” field set to the AID of the source station). In one implementation, the AID12 may be used to convey a session identifier corresponding to the direct link session (the source and destination stations involved in the direct link communication are thus obtained). This can be envisaged when the AP has allowed the P2P session (like for DLS protocol) and has granted an identifier to the session. In a preferred approach, the session identifier is constrained to the AID format of 12 bits; it is then up to the AP to allocate values distinct from those assigned to AIDs identifying individual stations.

Alternatively, several AIDs can be signalled for a given RU, which would allow to inform of the source and receiving P2P stations. Alternatively, for non-established direct link sessions, the AID of a peer non-AP 802.11ax destination station maybe unknown by the non-AP 802.11ax station. Thus, the usage of a MAC address may be envisaged instead of a station identifier (AID), because this kind of address is universally known and more especially shared with the AP and the stations (because the AP has allowed registration onto the BSS to the peer non-AP 802.11ax destination station). The AP may also retrieve the AID from the received MAC address, and advertises the AIDs of stations for subsequent resource allocation.

Alternatively, the given RU is associated with a distinct BSSID (as example, the AID12 field contains a specific AID value corresponding to a distinct BSSID; alternatively, a MAC address is provided with the value of intended BSSID). Thus, the AP corresponding to the specified BSSID is the triggered station. As a result, this second AP can send frames to stations associated with its specified BSSID, inside the given RU provided by the first AP.

At step 602, the AP sends an indication indicating whether the STA is allowed to choose values of the set of transmission parameters for transmitting data over the allocated resource unit. Alternatively, the indication may indicate whether values for the set of transmission parameters to be used by the STA for transmitting data over the resource unit need to be those provided by the AP or the choice of the values is left to the STA.

Decision to include such indication element for station transmission mode in a given RU may be based on various criteria at the AP, for instance based on previous Buffer Status Reports received from the non-AP stations. In a variant, a RU allocated for DiL transmission may always have the indication element set.

Preferably, the number of UL RUs having the indication element set is included in the number of available PHY block transmission chains at the AP (the AP may have several radio and antenna systems). The AP will not limit the number of DiL RUs (or the RUs intended for other BSSs) having the indication element set against its reception capabilities, because the AP is not a receiving station of such RUs.

In a preferred embodiment, the AP would make the UL RUs with the indication element unset (or RUs without the indication element) contiguous, such that a single block transmission chain is used to decode all the range of UL RUs (this is because those UL RUs share the same PHY preamble).

Then the trigger frame is sent, by the PHY of the AP, to triggered STAs (usually non-AP stations of its BSS, but also any AP managing its own distinct BSS).

Optionally, at step 603, in the allocated RU is an uplink RU, the AP receives data frame over the RU allocated by the AP to the STA using values determined based on indication.

If the allocated RU is an DiL RU, the destination STA receives data frame over the RU allocated by the AP to the STA using values determined based on indication.

If the allocated RU is an RU for distinct BSS, the destination STAs receive data frame over the RU allocated by the AP to the AP of second BSSID using values determined based on indication.

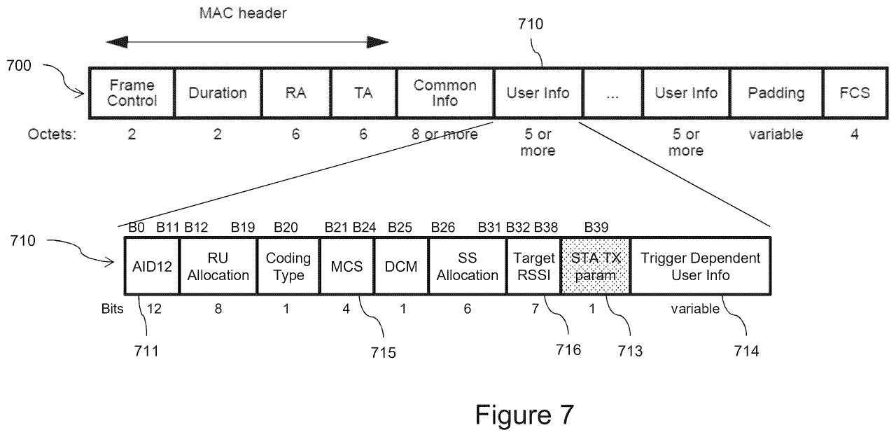

FIG. 7 illustrates the structure of a Trigger Frame 700 according to embodiments of the invention. In this exemplary embodiment, the TF contains an explicit indication field.

Embodiments of the present invention provide a trigger frame wherein the User Info field 710 is a variant of the 802.11ax User Info field; the bit B39 (previously unused) is used as an indicator for specifying to the triggered STA that it has (or has not) to consider its own transmission parameters when issuing the HE PPDU in the corresponding RU.

The subfield bit B39 is a signalling element that may be named “transmission mode” or “STA TX parameter” or any other appropriate name.

According to embodiments, the B39 subfield 713 comprises a value specifying that transmission parameters values contained in the TF have to be used (e.g. B39 is unset, or value 0). According to embodiments, trigger frame parameters to consider are MCS subfield 715 and Target RSSI subfield 716.

The B39 subfield 713 comprises a value specifying that the triggered STA will not use the transmission parameters indicated in the Trigger Frame, but has to use its own locally determined (chosen) values of the transmission parameters (e.g. B39 is set, or value 1).

Therefore, use of subfield B39 is advantageously backward-compatible with the existing 802.11ax TF format.

The User info field 710 may further contain an AID12 subfield 711 and a Trigger dependent User Info subfield 714.

According to other embodiments, in case where embodiments of the invention are only applied to Direct Link RU communications (and never for UL RUs), then no explicit signalling is required; the determination that a RU is a Direct Link RU is one means to determine that the signalling element is set. As already discussed, the AID12 711 may convey a session identifier corresponding to the direct link session, or two AID12 can be specified for identifying the two P2P non-AP stations, or alternatively two MAC addresses can be specified.

According to other embodiments, no explicit signalling is required when the triggered STA is a second AP. The usage of BSSID (or a value derived from it) of the second AP for RU allocation is sufficient to determine that the signalling element is set. As already discussed, the AID12 may convey MAC address which is a BSSID different from the MAC address (BSSID) of the triggering AP.

FIG. 8a illustrates a transmission sequence according to embodiments of the invention.

The trigger frame 210 has a non-HT Duplicate format, and is replicated on each 20 MHz channel forming the operating reserved band (e.g. 40 MHz for the sake of illustration).

Preferably, the conventional MU UL RU are specified to occur on the primary 20 MHz channel, that is to say the channel where the AP has contended its medium access. For those RUs, the indication, to indicate whether a transmission parameter value for transmitting data over the RU is set by the AP or by the source station, is unset.

As a result, the non-AP stations (STA1, STA7, STA3 and STA5) will emit a UL frame according to the HE TB PPDU (FIG. 3c), where all Pre-modulated fields 360c are emitted by the stations over the 20 MHz width.

Preferably, the RUs on the secondary channel (RU5 and RU6) have the indication (that indicates whether a transmission parameter value for transmitting data over the RU is set by the AP or by the source station) set according to embodiments of the invention.

As a result, the non-AP stations (STA2 and STA6) will emit a triggered frame according to the HE SU PPDU (FIG. 3a), where each Pre-modulated fields 360a are emitted by the station over same frequency width as the determined RU. This is because this format contains parameters useful for the receiver to decode the PPDU (through analysis of the HE-SIG-A field).

The station STA2 transmits its frame 822 within a HE SU PPDU format all along the RU5. The station STA2 indicates in the HE-SIG-A field the chosen values of the transmission parameters.

After decoding the legacy preamble, the PHY entity of a receiving station should begin receiving the sequence of HE-SIG-A, HE-STF, and HE-LTF for HE SU PPDU; the receiving station evaluates HE-SIG-A (checks contents in HE-SIG-A) for a supported mode. The HE-MCS representing the modulation and coding is notably carried in the HE-SIG-A field, allowing the receiving station to correctly decode the following HE modulated fields 361a.

In the same way, the station STA6 transmits its frame 821 within a HE SU PPDU format all along the RU6.

One may note the difference with a conventional triggered mechanism of 802.11ax standard; the preambles 230, 830 and 831 of the figure are different. The new trigger mechanism of embodiments of the invention provides usage of various preambles in the Rus; either conventional Pre-HE modulated fields 360c (for 230) or Pre-HE modulated fields 360a (for 830 and 831).

In embodiments, the data frame transmitted by either STA2 or STA6 may use a multi-user (MU) format wherein only one STA (STA2 or STA6) is listed in the HE-SIG-B field.

Next, the receiving station (respectively STA4 and AP in the example) may acknowledge the transmission on the OFDMA RU with an Ack or Block Ack Frame (respectively 842 and 841). Preferably, those Ack frames are also sent according to the SU PPDU format.

As a conclusion, the RU characteristics, such as location, width, and length, are still indicated by the trigger Frame ( ). The invention provides dedicated fitting method, wherein values for the transmission parameters within the specified RU may be decided by the triggered transmitting station.

FIG. 8b illustrates another transmission sequence according to embodiments of the invention, wherein the RU for which an indicator is set has a 20 MHz width.

More precisely, as the RU size is counted in number of tones, the exemplary illustration provides that a 242-tones RU is aligned on a 20 MHz channel. Possibly, the RU size corresponds to a multiple of 20 MHz channel (that is to say the RU size is set to the maximum bandwidth of n*20 MHz channels).

This provides a great advantage, as the HE-SIG-A field conventionally has a 20 MHz width. Existing 802.11 standard mandates to duplicate the HE-SIG-A field over each occupied 20 MHz channel of the channel bandwidth.

Contrary to the example illustrated in FIG. 8a, now RU5 and RU6 have a 20 MHz width, so that the full operational band reserved by the TF 210 becomes 80 MHz.

One may note the difference with the triggered mechanism of 802.11ax standard; the preambles 230, 830 and 831 of the figure are all transmitted on a 20 MHz basis but they are different. The new trigger mechanism according to embodiments of the invention provides usage of various preambles in the RUs; a preamble may be a conventional Pre-HE modulated fields 360c for HE TB PPDUs (for 230), but may also be a Pre-HE modulated fields 360a for HE SU PPDUs (for 830 and 831).

As a recall, Pre-HE modulated fields 360b for HE MU PPDU (for 830 and 831) can also be used, wherein only STA2's AID is listed in the HE-SIG-B 350 of preamble 830 and only STA6's AID is listed in the HE-SIG-B 350 of preamble 831.

Finally, each STA (STA6 and STA2) uses its own preamble on its distinct channel (in other words, uses its own PPDU format in its allocated RU). Major advantage is that those concerned stations do not require synchronization (like for the legacy triggered-based stations that do MU UL transmission towards the AP), providing they shall meet the TXOP limitation (RU Length).

Alternatively, only part of the pre-HE (or pre-EHT) modulated fields is synchronized. For example, the fields from L-STF to HE-SIG-A (FIGS. 3a to 3c) are aligned in starting time and duration.

In addition, the AP does not need to be aware of P2P transmission characteristics (so does not provide all trigger parameters, e.g. MCS). Only TXOP length (via RU length attribute) would be helpful for the recipient STA(s) as they shall meet this requirement.

Preferably, the selected RU location corresponds to secondary channel(s).

The 802.11ax standard has also considered a 20 MHz-only operational mode for 802.11ax client stations. Via management frames, client stations will be able to inform an 802.11ax AP that they are operating as 20 MHz-only client stations. Usually 20 MHz-only stations can only communicate via OFDMA RUs within the 20 MHz primary channel.

Embodiments of present invention provide support for those 20 MHz-only client stations by offloading their operating band on one of secondary 20 MHz channels during the granted TXOP (that is to say either the secondary 20 MHz, tertiary 20 MHz or quaternary 20 MHz sub-channel of an 80 MHz band). The allocated RU can be used as a classical 20 MHz channel (that is to say as non-OFDMA 20 MHz, and not as a 242-tone RU), as the HE SU PPDU format is used within this band.

The invention provides embodiments for new Fast session transfer (FST) protocol, which allows different transmission sessions to transfer smoothly from one channel to another.

This new protocol makes a 20 MHz only device taking benefit of the larger bands offered by 802.11 standard, and avoids limiting it operations on the sole 20 MHz primary channel as of today.

FIG. 8c illustrates another transmission sequence according to embodiments of the invention, wherein the RU for which an indicator is set can be perceived as an allocation of band for a given set of stations.

As illustrated, the RU5 is considered by triggered stations as a band of operation in a SU communication style; each frame transmission is separated by a SIFS interspace. For example, the couple 830A/840A corresponds to a data transmission from STA2 to STA4, whereas the couple 830B/840B is the acknowledgment emitted by STA4.

As the HE SU PPDU format is to be used for all frames transmitted in a RU having the indicator set according to embodiments of the invention, then several SU protocols can be envisaged (under the constraint of the TXOP duration, in other words the RU length, is guaranteed and not exceeded).

As already discussed, the PHY preambles 830A-830B-830C have preferably the same frequency width as the related data 840A-840B-840C, that is to say a 20 MHz width. Alternatively, the width of the related data 840A-840B-840C may be slightly narrower by reserving an empty 26-tone RU(s) at any channel edge to limit interferences (as example, an empty 26-tone RU is scheduled, e.g. RU with AID=2046, inside the RU5 at the channel bound close to the primary channel).

This can be the case of the ‘Reverse Direction Grant’ Protocol, where the triggered source 802.11 station corresponds to the Reverse Direction (RD) initiator and the triggered destination 802.11 station is the Reverse Direction (RD) responder.

The RD initiator that grants the RDG Transmit Opportunity shall ensure not bypassing the remaining RU length. Otherwise, the last PPDU shall be padded with padding (dashed lines inside 840C MAC frame).

As a result, the invention has provided means to allocate a frequency/time slot for classical SU communications.

Embodiments of the invention provide several advantages as they take combined benefits of Multi-User and Single-User operations, which enhances the global cell's efficiency. The provided scheme is more efficient compared to SU medium-access schemes (former EDCA Direct-Link protocols, RDP protocol, etc.), as the P2P communications is triggered by an AP (avoid medium access collisions). The scheme is backwards compatible with classical MU UL operations, as AP can still simultaneously receive classical OFDMA Uplink RUs from other STAs

FIG. 8d illustrates another transmission sequence according to embodiments of the invention, wherein the RU for which an indicator is set can be considered as an allocation of band for a set of stations belonging to another BSS (that is to say for a BSS managed by an AP different from the AP that emits the trigger frame 210).

Embodiments provide that several kinds of PPDU format can be used for frames of other BSS transmitted in a RU having the indicator set according to the invention.

As example, the Trigger Frame 840D can be sent by the triggered AP (second AP) over the reserved RU, in either a MU or SU format. This frame is used to trigger stations of the second BSS managed by a second AP (e.g. AP2). Thus, stations of BSS2 may detect this second TF and emit their triggered frames 840E. The RU Allocation provided by Trigger Frame 840D of AP2 shall ensure the secondly triggered RUs are encompassed inside the granted RU by AP1.

As other example, a MU Downlink frame (840F) may also be conveyed inside the RU granted by AP1, wherein AP2 sends several AMPDUs for multiple users of its BSS (BSS2).

The PHY preambles 830D-830E-830F may have the same frequency width as the related data 840D-840E-840F, that is to say a 20 MHz width. Alternatively, the width of the related data 840D-840E-840F may be slightly narrower. For example, an empty 26-tone RU (e.g. RU with AID=2046) is located at any channel edge to limit interferences. With regards to FIG. 8d, the RUs with reference 850 are not used (empty) as they are close to the primary channel.

As a result, invention embodiments provide that AP2 uses its own transmission parameters inside the RU granted by AP1, except that bandwidths of PPDUs shall fit inside AP1's RU width. As illustrated, preferred embodiments consider a 20 MHz width for the granted RU by AP1.

One advantage of such a scheme consists in providing a coordination by first AP (AP1) for several second APs, each operating in distinct 20 MHz RUs, which thus avoid interference in between second APs.

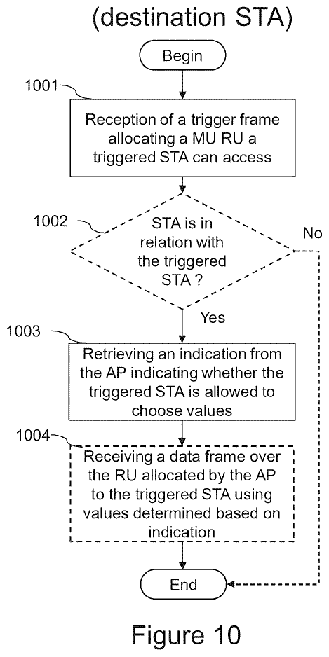

FIG. 10 illustrates using a flowchart, embodiments of the invention implemented at a destination station to be ready to configure itself as being a receiver of a TB PPDU transmission from a triggered STA as a result of a received Trigger Frame.

More specifically, a triggered STA may be a source STA in a context of DiL transmission, whereas a destination STA would be a recipient of the DiL transmission.

In the context of inter-AP coordination, the triggered STA is a second AP (e.g. AP2) that is listed in RU Allocation of the received Trigger Frame from triggering AP (e.g. AP1). A destination STA may be any non-AP station pertaining into the second BSS (e.g. any non-AP STA associated with AP2).

At step 1001, the destination STA receives a trigger frame allocating a MU RU that a triggered STA can access for sending data. The RU can be either a scheduled RU for the triggered STA or a Random RU.

One may note that the TF does not include the destination STA as a recipient of the TF (the destination does not see itself in the TF's receiver address nor in RU Allocation list).

Optionally, a test 1002 is performed for determining if the received TF is of relevant for the triggered STA, i.e. whether the STA is in relation with the triggered STA.

In case of DiL transmission, the triggered (destination) STA may determine whether the TF is issued from its local AP; TA field is set to a BSSID value that corresponds to the AP with which the STA is associated (or at least a transmitted BSSID related to a same physical AP in case of multiple BSS support). In case where the TF is issued from the local AP, the destination STA searches further for either its AID or a DiL session AID inside the RU Allocation field in order to continue the operations. If the destination STA finds its AID or is concerned by the session AID, then the test 1002 is considered as positive and the algorithm continues at step 1003.

Even if the transmission is not DiL, a STA may not directly ignore at step 1002 a TF from a remote AP, because the STA has to determine first if it is a destination STA. As a result, legacy behavior for setting the NAV in reception to a TF has to be modified.

Embodiments may envisage a new Trigger Type for such TF 700 (The Trigger Type subfield in the Common Info field identifies the Trigger frame variant, and a new value is specified for AP Coordination), such that a STA receiving a TF with the new TF variant value will analyze each User Info element.

Other means can be envisaged for allowing analysis of the TF received from a remote AP in a vicinity of a STA. As example, a STA could have previously determined that its associated AP has informed of supporting an AP Coordination capability through the list of capabilities advertised in management (e.g. beacon or probe response) frames the AP transmits.

A receiving STA considers itself as a destination STA if it has found its AP in the list of triggered stations. As already discussed, as example, an AID12 of a User Info field may convey a BSSID corresponding to the AP to which it is associated.

A STA that is stated as a destination STA (test 1002 positive) will continue the algorithm at step 1003.

Step 1003 is similar to step 502, wherein the destination STA retrieves an indication from the AP (sending the TF) indicating whether the triggered STA (e.g. a triggered non-AP STA for DiL, or a triggered AP for AP coordination) is allowed to choose values. The indication is preferably retrieved from a field of the trigger frame.

If an indicator is present and specifies that the triggered station decides about the transmission parameters, the destination station thus prepares itself to receive in the DiL RU; the used parameters will be determined at reception of PPDU, by analysis the PHY preamble as it would have done for single user mode. The PHY preamble expected to have the same width as the related data.

If no indicator is present, or an indicator specifies that the transmission parameters to consider are those of Trigger Frame, the destination station thus prepares itself to receive in the DiL RU in conventional way; the PHY preamble will have a 20 Mhz width and then the related data is received over the RU.

According to preferred embodiments disclosed through FIGS. 8c and 8d, the RU width is one or multiple of 20 MHz contiguous bands.

Thus, the destination STA has to switch its primary channel to the temporary RU channel as indicated in the trigger frame. If the RU is greater than 20 MHz, then only one 20 MHz channel is the primary and the other channel(s) is (are) secondary channel(s).

Next, the non-AP destination STA configures its Physical, PHY, layer in a receive state to receive a PPDU frames (1004) over the resource unit or the 20 Mhz channel encompassing the resource unit (in response to the trigger frame).

In the context of AP coordination, the coordinated AP (second AP) and its associated STAs (the destination STAs) switch their primary channel to the temporary RU channel as indicated in the trigger frame. After the coordinated OFDMA duration (end of TXOP granted by first AP), the coordinated AP and its associated STAs switch back to their original primary channel.

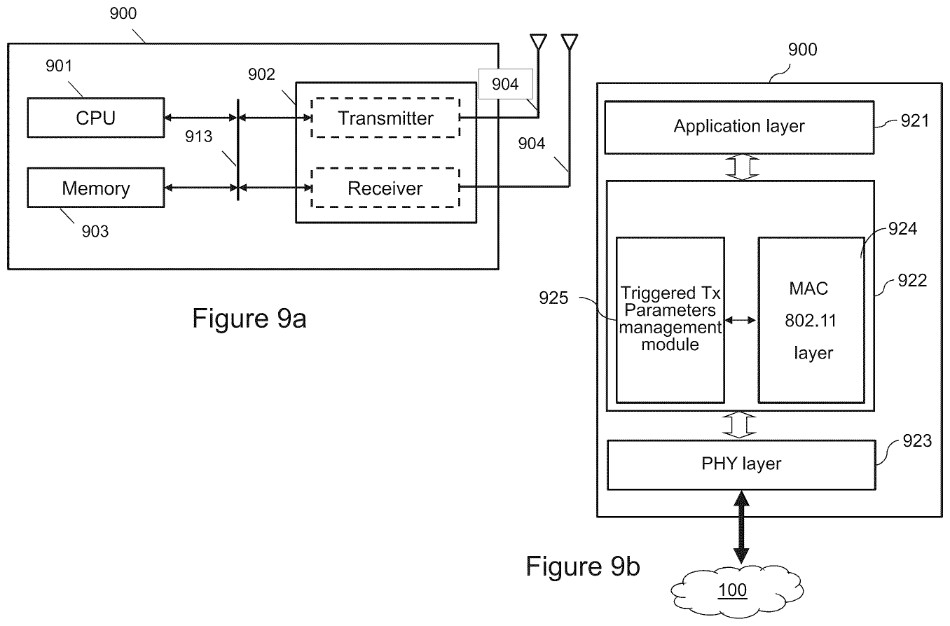

FIG. 9a schematically illustrates a communication device 900, either a non-AP station 101-107 or the access point 110, of the radio network 100, configured to implement at least one embodiment of the present invention. The communication device 900 may preferably be a device such as a micro-computer, a workstation or a light portable device. The communication device 900 comprises a communication bus 913 to which there are preferably connected:
a central processing unit 901, such as a processor, denoted CPU;
a memory 903 for storing an executable code of methods or steps of the methods according to embodiments of the invention as well as the registers adapted to record variables and parameters necessary for implementing the methods; and
at least one communication interface 902 connected to a wireless communication network, for example a communication network according to one of the IEEE 802.11 family of standards, via transmitting and receiving antennas 904.

Preferably the communication bus provides communication and interoperability between the various elements included in the communication device 900 or connected to it. The representation of the bus is not limiting and in particular the central processing unit is operable to communicate instructions to any element of the communication device 900 directly or by means of another element of the communication device 900.

The executable code may be stored in a memory that may either be read only, a hard disk or on a removable digital medium such as for example a disk. According to an optional variant, the executable code of the programs can be received by means of the communication network, via the interface 902, in order to be stored in the memory of the communication device 900 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 9b is a block diagram schematically illustrating the architecture of the communication device 900, either the AP 110 or one of stations 101-107, adapted to carry out, at least partially, the invention. As illustrated, device 900 comprises a physical (PHY) layer block 923, a MAC layer block 922, and an application layer block 921.

The PHY layer block 923 (here an 802.11 standardized PHY layer) has the task of formatting, modulating on or demodulating from any 20 MHz channel or the composite channel, and thus sending or receiving frames over the radio medium used 100, such as 802.11 frames, for instance medium access trigger frames TF 510 (FIG. 7) to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 922 preferably comprises a MAC 802.11 layer 824 implementing conventional 802.11ax MAC operations, and additional block 925 for carrying out, at least partially, the invention. The MAC layer block 922 may optionally be implemented in software, which software is loaded into RAM 903 and executed by CPU 901.

Preferably, the additional block 925, referred to as Triggered Tx Parameters management module for selecting transmission parameters applied to transmissions following a medium access trigger frame through OFDMA resource units (sub-channels), implements the part of embodiments of the invention (either from station perspective or from AP perspective).

For instance, and not exhaustively, the operations for the station (AP or non-AP) may include, at the AP, generating and sending a trigger frame allocating a RU for DiL or UL transmission, wherein the TF indicates whether a transmission parameter for transmitting data over the RU is set by the AP or by the source station. The operations at the non-AP station may include configuring the PHY for emission/reception over DiL/UL RUs according to the provided indication, that is to say the transmitted PPDU frame has a HE SU PPDU when the indication is provided (otherwise follows the HE TB PPDU format commonly used for triggered operations).

MAC 802.11 layer 924, Triggered Tx Parameters management module 925 interact one with the other in order to process accurately communications over OFDMA RU addressed to multiple stations according to embodiments of the invention.

On top of the Figure, application layer block 921 runs an application that generates and receives data packets, for example data packets such as a video stream. Application layer block 921 represents all the stack layers above MAC layer according to ISO standardization.

Although the present invention has been described hereinabove with reference to specific embodiments, the present invention is not limited to the specific embodiments, and modifications will be apparent to a skilled person in the art which lie within the scope of the present invention.

In particular, the different HE frame formats described from different embodiments may be replaced by EHT frame formats, where appropriate.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for wireless communication comprising, at a station (STA):
receiving, from an access point (AP), a trigger frame to trigger a multi-user (MU) transmission, wherein the trigger frame allocates a resource unit of the MU transmission for data transmission from the STA using a set of transmission parameters and wherein the resource unit occupies a frequency bandwidth that is multiple of 20 MHz channels;
choosing, by the STA, values for part or all of the set of transmission parameters; and
sending a frame over the resource unit of the MU transmission allocated by the AP to the STA using the values chosen by the STA.

2. The method of claim 1, wherein the trigger frame includes values chosen by the AP for the set of transmission parameters.

3. The method of claim 2, wherein the AP chosen values are specified for an uplink transmission towards the AP.

4. The method of claim 2, wherein the AP chosen values are specified in an Info field of the trigger frame in accordance with IEEE 802.11 standard.

5. The method of claim 2, wherein, for at least one transmission parameter, the value chosen by the STA is different from the value chosen by the AP.

6. The method of claim 2, wherein the choosing step is conditional upon one or more conditions, wherein the one or more conditions include one or more from amongst the following conditions:
the condition that the resource unit of the MU transmission is allocated for sending the frame in direct link (DiL) from the STA towards another STA, the AP managing stations of a first basic service set (BSS),
the condition that the STA acts as an access point for a second BSS,
the condition that a value provided by the AP is not recognized, not supported or cannot be satisfied by the STA, and the resource unit being formed by a group of adjacent sub-carriers encompassed in a composite channel that is multiple of 20 MHz channels, thereby the frequency bandwidth of the composite channel being greater or equal than that of the resource unit, and the frame including a preamble and a payload, wherein the sending step comprises sending the payload over the resource unit and sending the preamble over each 20 MHz channel of the composite channel, and
the condition that the STA is the only station sending a preamble over each 20 MHz channel of the composite channel.

7. The method of claim 1, wherein the frame has a preamble field that contains, for at least one transmission parameter, the value chosen by the STA.

8. The method of claim 7, wherein the preamble field containing the chosen value is an HE-SIGA field in accordance with IEEE 802.11ax standard and/or contains the value of a modulation or coding scheme (MCS) parameter chosen by the station.

9. A method for wireless communication comprising, at a station (STA):
receiving, from an access point (AP), a trigger frame to trigger a multi-user (MU) transmission, wherein the trigger frame allocates a resource unit of the MU transmission for data transmission from the STA using a set of transmission parameters and wherein the resource unit occupies a frequency bandwidth that is multiple of 20 MHz channels;
determining values for the set of transmission parameters; and
sending a frame over the resource unit using the determined values;
wherein the determining is based on an indication from the AP indicating whether the STA is allowed or not to choose values for the set of transmission parameters.

10. A non-transitory computer-readable medium storing a program which, when executed by a microprocessor or computer system in a device, causes the device to perform the method of claim 1.

11. The method of claim 9, wherein the indication is comprised in a field of the trigger frame received from the AP.

12. The method of claim 9, wherein the trigger frame allocates one resource unit of the MU transmission for data transmission from the STA.

13. The method of claim 9, wherein, if the indication has a non-zero value, the station chooses values for the set of transmission parameters.

14. The method of claim 1, wherein the sent frame is not a triggered-based frame.

15. The method of claim 14, wherein the frame is a single-user (SU) frame sent over the resource unit of the MU transmission.

16. The method of claim 14, wherein a plurality of frames are sent sequentially over the resource unit and wherein each frame transmission is separated by a SIFS interspace.

17. The method of claim 9, wherein based on the indication, the trigger frame comprises a field indicating an allocation duration allocated to the STA within the TXOP obtained by the AP.

18. The method of claim 17, wherein the allocation duration corresponds to a RU length.

19. The method of claim 17, wherein one or more frames are sent over the resource unit and wherein the frame transmission(s) duration fits entirely within the allocation duration.
